(19) United States
(12) Patent Application Publication
(10) Pub. No.: US 2010/0002772 A1
(43) Pub. Date: Jan. 7, 2010

(54) METHOD AND DEVICE FOR RESTORING A VIDEO SEQUENCE

(75) Inventor: Benoit Vandame, Betton (FR)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/498,052

(22) Filed: Jul. 6, 2009

(30) Foreign Application Priority Data
Jul. 4, 2008 (FR) 0854561

(51) Int. Cl. H04N 7/64; G06K 9/40

(52) U.S. Cl. 375/240.16; 375/E07.279; 382/260

(57) ABSTRACT

In order to restore a video sequence consisting of a plurality of images each comprising at least one block of pixels: the value of the similarity between a block of pixels to be restored in the current image and a plurality of blocks of a reference image is calculated (10); the block of the reference image for which the value of the similarity is an extremum is determined; a similarity map is constructed (12) around the extremum; the similarity map is modeled (14) so as to obtain a model defined by a predetermined number of parameters; a local restoration filter is constructed (16) from the parameters of the model; and the pixels of the block to be restored are filtered (18) by applying to them the local restoration filter.

The present invention relates to a method and device for restoring a video sequence.

More precisely, the present invention concerns the restoration of a sequence of images on the basis of calculations of similarity between images during a video coding by blocks.

Restoration of images means a technique for enhancing the quality of the images.

Among the various known techniques for enhancing images, there are in particular denoising, resampling, image inpainting, the enhancement of details, etc.

The restoration of images is not a trivial problem since the images to be processed have many highly varied characteristics, such as strong edges or contours, projecting corners or points, textures, noise, etc.

Each of these characteristics has very different spatial and frequential properties. A restoration of the denoising type supplies an image with less noise, whilst preserving the other characteristics. A restoration of the detail enhancement type supplies an image with more marked details whilst keeping the noise level unchanged.

The various characteristics of an image are difficult to discriminate and only complex algorithms afford a high-quality restoration. In practice, restoration is often imperfect. For example, the denoising of an image is generally accompanied by a partial smoothing of the textures and/or slight diffusion of the edges.

Certain restoration methods use so-called anisotropic convolutions: a convolution kernel is calculated for each pixel according to its adjoining pixels. Such approaches make it possible to adapt the convolution locally to take account of the characteristics of the image processed. These algorithms involve many calculations and the processing time for small images is typically measured in seconds.

The restoration of a video sequence in real time is particularly useful for the transmission of a video coded on the fly with the most instantaneous possible reception. It is then a case of restoring each of the images in the sequence at the coding rate. In the case of restoration of the denoising type, it is sought for example to compress the video signal better for the same visual quality.

The present invention aims to allow the restoration in real time of images in a video sequence, that is to say at least as quickly as the mean duration of coding of an image in the sequence.

This implies a drastic acceleration of current restoration methods.

The restoration of images by local filtering can be decomposed into two steps: first of all, for each pixel, a convolution kernel is calculated according to local characteristics of the pixel; then the convolution kernel is applied to the pixel in question and its vicinity.

These steps are both complex and involve many calculations. Nevertheless, it can be considered that the calculation time of the step of applying the convolution kernel can be reduced significantly by using dedicated processors, such as for example so-called multi-core processors or graphical processor units (GPU). On the other hand, the step of calculating the convolution kernel, which is difficult to carry on dedicated processors because of its complexity, remains very expensive in terms of calculation time.

The present invention seeks mainly to accelerate the calculation of the local convolution kernel.

Various methods are known for calculating the convolution kernel for a given pixel: anisotropic filters, methods based on partial differential equations (PDEs), or non-local means (NL means).

For certain methods based on PDEs, the convolution kernel, defined for a pixel, is equal to a two-dimensional Gauss function characterized by three parameters: the semi-major axis, the semi-minor axis and the orientation of the semi-major axis. It should be noted that the amplitude is not a parameter of the model since the entire convolution kernel must be equal to unity in order to preserve the mean intensity of the pixels of the image to be restored.

For a pixel close to a contrasted edge, the Gaussian convolution kernel is very elongate and oriented in the direction of the edge. For a pixel of a homogeneous zone, the convolution kernel is wide and isotropic (same semi-major and semi-minor axes). For a pixel of a textured zone, the convolution kernel is chosen to be small and isotropic. The action of the convolution is to diffuse the pixels according to the Gauss function so that the details are preserved and the noise is smoothed. The Gaussian smoothing will therefore be intense in a homogeneous zone, weak in a textured zone in order not to lose the fine details, and spread along contrasted edges.

In the case of methods based on PDEs, the calculation of the three parameters characterizing the Gaussian function is done by calculating the local gradients at the pixel in question. The gradients make it possible to calculate the orientation and the intensity, that is to say the contrast, of the local edges. The convolution kernel is then constructed by sampling this Gauss function.

The article by A. Buades et al. entitled “A review of image denoising algorithms, with a new one”, published in Multiscale Modeling & Simulation vol. 4, No. 2, pages 490 to 530, 2005, describes in particular an algorithm of the non-local means for restoration of the denoising type.

However, the technique described in this document is not compatible with the real-time coding of video sequences.

The aim of the present invention is to remedy the drawbacks of the prior art.

For this purpose, the invention provides a method of restoring a video sequence consisting of a plurality of images each comprising at least one block of pixels, remarkable in that it comprises the steps of,
obtaining a plurality of values of the similarity in the sense of a similarity metric, between a bloc of pixels to be restored in the current image and a plurality of blocks of a reference image linked to the current image by a motion vector field, using intermediate data obtained in the calculation of the motion vector field;
constructing a local restoration filter using the plurality of similarity values obtained; and,
applying said local restoration filter to the pixels of the block to be restored.

Thus the invention makes it possible to restore the pixels of the blocks to be coded using the intermediate calculations of the motion estimation made by the coder.

This is because the motion estimation measures similarities between the block of pixels to be coded and blocks of pixels of the reference image. The invention proposes to use these similarity measurements in order to derive therefrom a filter specific to the restoration of the pixels of the block to be coded, thus avoiding the numerous calculations that would be necessary for characterizing the pixels of the block to be coded and applying a filter that would depend on the characteristics calculated.

According to a particular embodiment, the intermediate data is the sum or mean of the absolute values of the differences between the values of the pixels of a block of the reference image and the values of the corresponding pixels of the block to be restored of the current image. The sum or mean of the absolute values of the differences is a quantity that is very quick to calculate, in particular because of the processors including for this purpose dedicated machine instructions.

The present invention also provides a method of restoring a video sequence consisting of a plurality of images each comprising at least one block of pixels, remarkable in that it comprises steps according to which:

the value of the similarity is calculated, in the sense of a similarity metric, between a block of pixels to be restored in the current image and a plurality of blocks of a reference image linked to the current image by a motion vector field;

the block of the reference image for which the value of the similarity with the aforementioned block of the current image is an extremum is determined;

a similarity map is constructed around the extremum, from the values of the similarity of the blocks of the reference image close to, within the meaning of a proximity criterion, the block for which the value of the similarity is an extremum;

the similarity map is modeled so as to obtain a model defined by a predetermined number of parameters;

a local restoration filter is constructed from the parameters of the model; and

the pixels of the block to be restored are filtered by applying to them the local restoration filter.

Thus the invention makes it possible to restore the pixels of the blocks to be coded using the intermediate calculations of the motion estimation made by the coder.

This is because the motion estimation measures similarities between the block of pixels to be coded and blocks of pixels of the reference image. The invention proposes to use these similarity measurements in order to derive therefrom a filter specific to the restoration of the pixels of the block to be coded, thus avoiding the numerous calculations that would be necessary for characterizing the pixels of the block to be coded and applying a filter that would depend on the characteristics calculated.

In a particular embodiment, during the modeling step, the similarity map is modeled in the form of a surface.

A surface constitutes in fact the simplest modeling of the similarity map.

In a particular embodiment, the similarity metric consists of calculating the sum or mean of the absolute values of the differences between the values of the pixels of a block of the reference image and the values of the corresponding pixels of the block to be restored of the current image and the extremum is a minimum.

The sum or mean of the absolute values of the differences is a quantity that is very quick to calculate, in particular because of the processors 3Q including for this purpose dedicated machine instructions.

In a particular embodiment, in which a block is defined by its coordinates (x,y) and the block for which the value of the similarity is an extremum has as its coordinates (xₛ, yₛ), the proximity criterion consists of selecting the blocks whose coordinates satisfy |x−xₛ|<m and |y−yₛ|<m, where m is a predetermined distance.

The proximity criterion makes it possible firstly to limit the number of points to be modeled on the similarity map and therefore to simplify the calculations and the model, and secondly to remain close to the extremum where the similarity map has a simpler shape.

In a particular embodiment, during the modeling step, the least squares method is used.

The least squares method is rapid in terms of calculation time and makes it possible to resolve overdetermined systems, that is to say those containing more equations than unknowns.

In a particular embodiment, the reference image is the image preceding the current image in the video sequence.

This is because, in such a case, the movements between images are a minimum. The extremums of the similarity maps are therefore more marked and the restoration filters more precise.

According to a particular characteristic, the aforementioned plurality of blocks of the reference image are included in a search window of predetermined size.

This makes it possible to apply the invention to a video coder that calculates the motion vectors limitingly and non-exhaustively.

The local filter may be a convolution kernel or a median filter or an oriented filter.

These three types of filter are easy to implement and have a relatively low calculation cost.

In a particular embodiment, the model is a two-dimensional parabolic function and the local filter is a two-dimensional convolution kernel defined by a Gauss function.

There is in fact a correspondence of parameters between the parabolic model and the Gauss function.

In another particular embodiment, the model consists of four parabolic functions with one dimension.

This variant is particularly advantageous since the calculation cost of the four parabolas with one dimension is negligible.

According to a particular characteristic, the blocks of pixels are squares with sides of 16 pixels.

This makes it possible to apply the invention to a conventional video coder within the meaning of the MPEG consortium.

For the same purpose as that indicated above, the present invention also provides a device for restoring a video sequence consisting of a plurality of images each comprising at least one block of pixels, remarkable in that it comprises:
means for obtaining a plurality of values of the similarity, in the sense of a similarity metric, between a bloc of pixels to be restored (Mc) in the current image and a plurality of blocks of a reference image (Ir) linked to the current image (Ic) by a motion vector field, using intermediate data obtained in the calculation of the motion vector field;
means for constructing a local restoration filter using the plurality of similarity values obtained; and,
means for applying said local restoration filter to the pixels of the block to be restored

Likewise, the present invention also provides a device for restoring a video sequence consisting of a plurality of images each comprising at least one block of pixels, remarkable in that it comprises:

a module for calculating the value of the similarity, within the meaning of a similarity metric, between a block of pixels to be restored in the current image and a plurality of blocks of a reference image linked to the current image by a motion vector field;

a module for determining the block of the reference image for which the value of the similarity with the aforementioned block of the current image is an extremum;

a module for constructing a similarity map around the extremum, from the values of the similarity of the blocks of the reference image close to, within the meaning of a proximity criterion, the block for which the value of the similarity is an extremum;

a module for modeling the similarity map, adapted to obtain a model defined by a predetermined number of parameters;

a module for constructing a local restoration filter from the parameters of the model; and

a module for filtering the pixels of the block to be restored, adapted to apply the local restoration filter to these pixels.

Still for the same purpose, the present invention also relates to an information storage means that can be read by a computer or a microprocessor storing instructions of a computer program, remarkable in that it allows the implementation of a restoration method as succinctly described above.

Still for the same purpose, the present invention also relates to a computer program product able to be loaded into a programmable apparatus, remarkable in that it comprises sequences of instructions for implementing a restoration method as succinctly described above when this program is loaded into and run by the programmable apparatus.

The particular features and the advantages of the restoration device, of the information storage means and of the computer program product being similar to those of the restoration method, they are not repeated here.

Other aspects and advantages of the invention will emerge from a reading of the following detailed description of particular embodiments given by way of non-limiting examples. The description refers to the drawings that accompany it, in which:

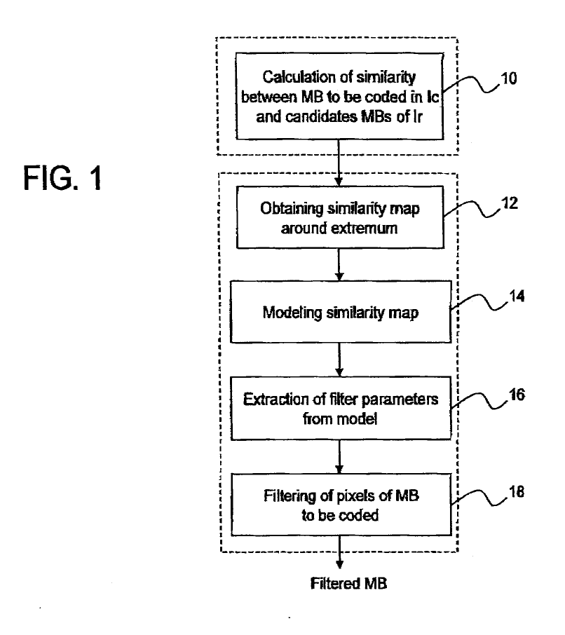

FIG. 1 is a flow diagram illustrating the mains steps of a method of restoring a video sequence according to the present invention, in a particular embodiment;

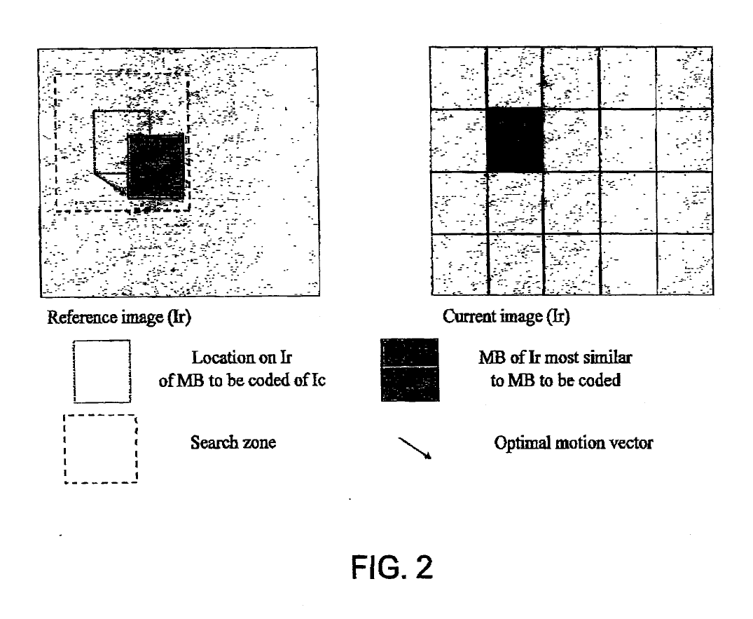

FIG. 2 depicts schematically the calculation of the motion estimation for a macroblock to be coded in the current image according to a reference image;

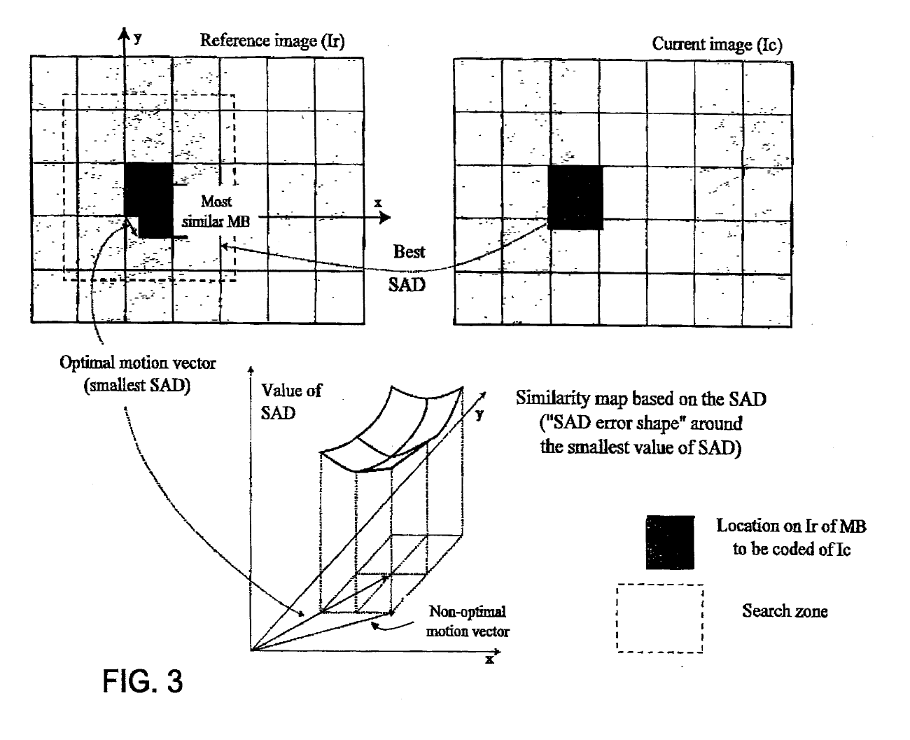

FIG. 3 illustrates a particular example of a similarity map calculated by an image coder;

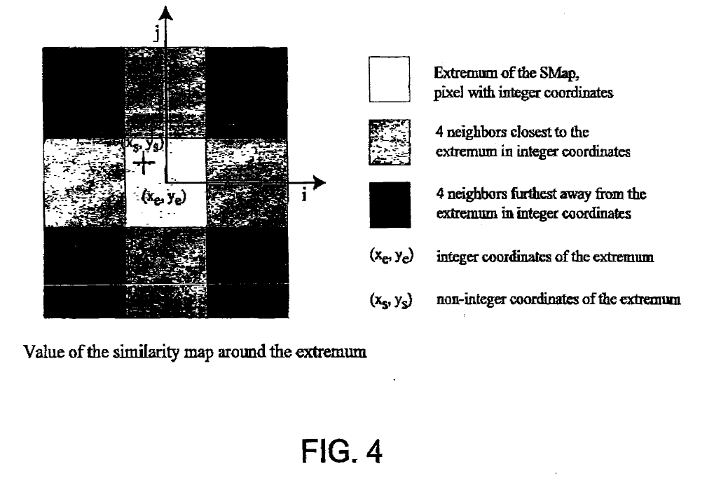

FIG. 4 illustrates a particular example of a similarity map for 9 pixels around an extremum;

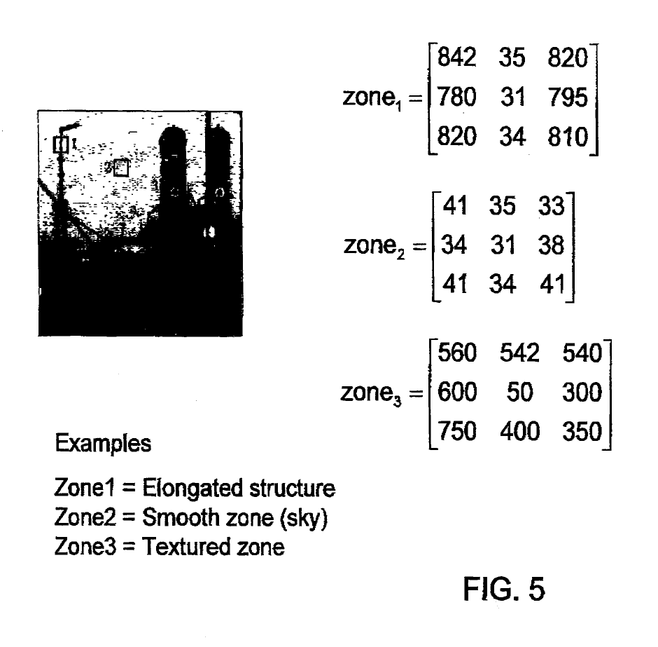

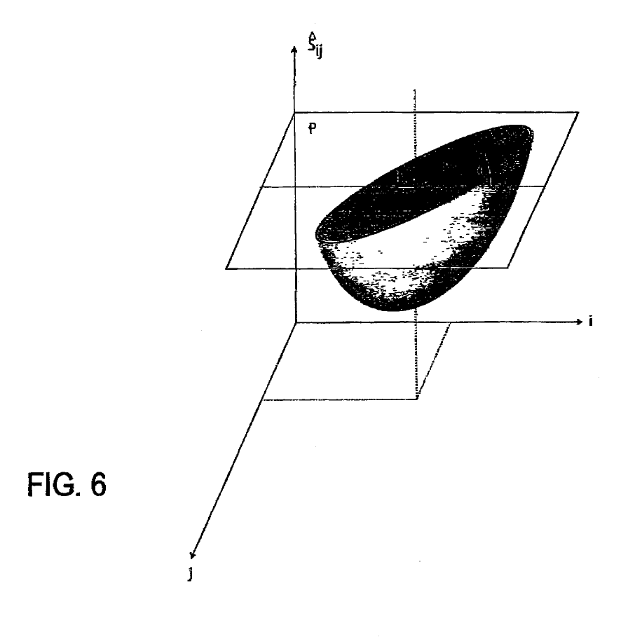

FIGS. 5 and 6 illustrate a particular example of a parabolic model for the similarity map;

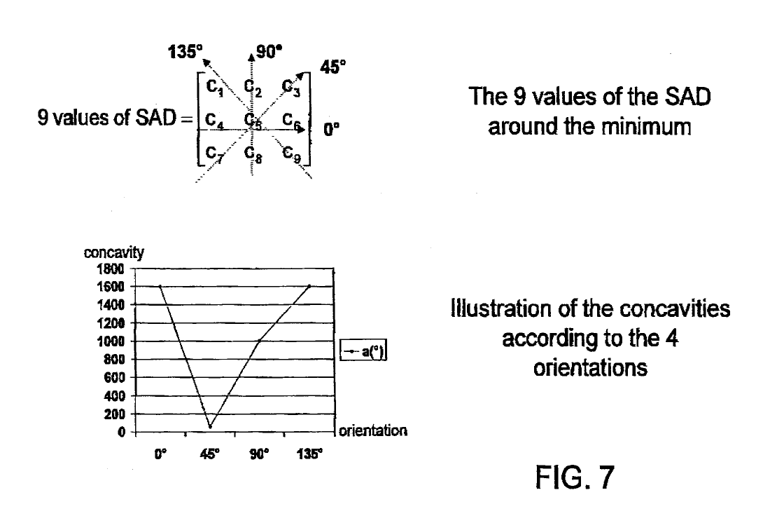

FIG. 7 illustrates an improved variant of the modeling of the similarity map;

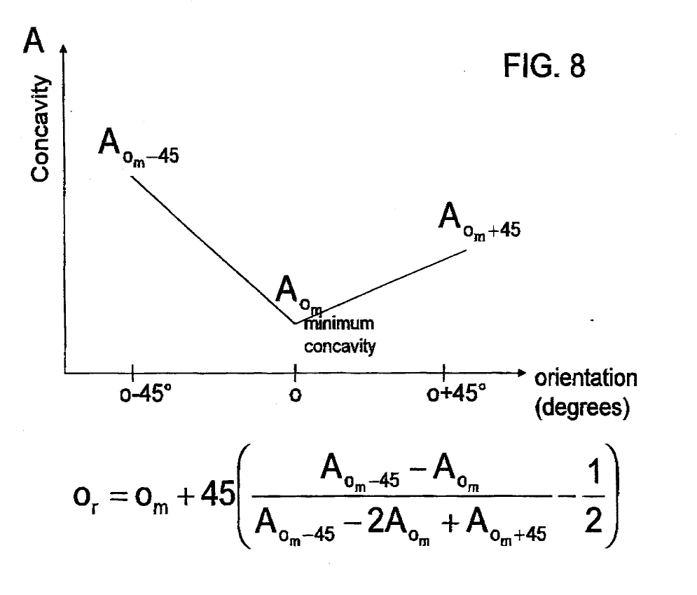

FIG. 8 illustrates a detail of the calculation of the orientation in the improved variant of FIG. 7; and

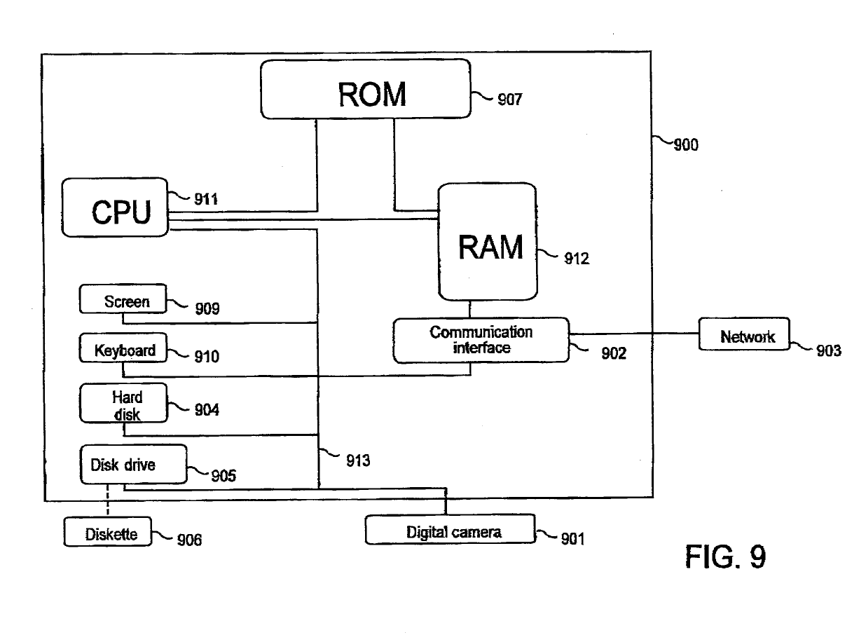

FIG. 9 depicts schematically a particular embodiment of an apparatus able to implement the present invention.

A video coded by blocks within the meaning defined by the Moving Picture Experts Group (MPEG) consortium, such as for example in the standards MPEG4 Part 2 and H.264, is considered.

The coder has several modes for coding an image of a video sequence, referred to as the current image.

An image in the sequence is divided into square blocks or pixels referred to as macroblocks. A macroblock will be designated hereinafter by the abbreviation MB.

In “P” mode, the current image is associated with a motion vector field. A motion vector translates, for each MB of the current image, a relative translation pointing to a reference image.

The MB to be coded is then subtracted from the pointed-to MB of the reference image. This subtraction defines the residue. It is almost zero if the movement between the reference image and the current image is zero or correctly approximated by a translation. This method, well known per se, is referred to as motion compensation.

For an MB of the P type, the coder codes the motion vector, the number of the reference image and the residue transformed by the discrete cosine transform (DCT). In practice, an MB is generally a square with sides of 16 pixels (with possibilities of sub-blocks in particular for MPEG4 and H.264 formats) and the reference image is often the image preceding the current image. The motion compensation therefore makes it possible to obtain an approximation of the current image from the reference image or images according to a vector field representing the translation of each of the MBs of the current image.

Calculation of the motion vectors is complex and represents a significant part of the coding time. It is a question of finding, for an MB of the current image, an MB of the reference image such that the residue, that is to say the subtraction of the two MBs, is minimum. Thus the optimal motion vector corresponds to the translation between the two MBs producing a minimum residue.

In other words, the two MBs must be the most similar within the meaning of a similarity metric.

It should be noted that the motion vectors can be calculated with a sub-pixel precision: the precision is ½ pixel for the standard MPEG4 Part 2 and ¼ pixel for the standard H.264. A non-integer motion vector corresponds to a reference MB interpolated by a fraction of a pixel, according to the standard used, in order to make possible similarity calculations with the MB of the current image. The advantage of calculating the motion vectors with a sub-pixel precision is to reduce the amplitude of the residues.

In practice, the similarity metric used is usually the sum of the absolute values of the differences (SAD, Sum of Absolute Difference) or the mean of the absolute values of the differences (MAD, Mean Absolute Difference). The MAD corresponds to a standardized SAD and has the same properties as the SAD.

The SAD is zero if the two MBs are identical, very large if they differ enormously. The SAD is therefore an inverse similarity metric.

In order to accelerate coding, the processors now include assembler instructions capable of calculating the SAD between several pixels (typically 8 or 16) in a minimum time. The specialized assembler instructions allow coding in real time. The most usual are described by the standard “Streaming SIMD Instruction” (SSE) developed for processing units (CPUs) in the ×86 family. The SSE standard has also come to be applied to other families of onboard processors.

Thus the invention proposes to determine the three parameters characterizing the Gauss function presented in the introduction (which will serve for filtering the video sequence with a view to its restoration) using similarity calculations made during the coding of the video sequence, using the intermediate data (e.g. SAD values) obtained from the similarity calculation made during the coding of the video sequence.

When an optimal motion vector is sought for an MB of the current image, the coder tests various candidate MBs of the reference image. The candidates are generally included in a delimited search zone. For each candidate, which is associated with a motion vector, an SAD value is calculated. Each of these values defines a point on a so-called SAD error shape representing the value of the SAD according to the motion vector. More generally, similarity map is spoken of.

Certain video formats (H.264, SVC) allow a free choice of a reference image with respect to an MB of the current image. The coder selects the best reference image according to an inherent strategy. The reference image being defined, the search by the coder for the optimal motion vector is applied as described previously.

The similarity map has a complex shape. The coder seeks its absolute minimum. The search may be exhaustive (all the points in this function are calculated) or iterative, with partial search essential for real-time coding. A three-step multiresolution search method can be applied, where the search is made for translations divisible by 8, then around the minimum found, the search continues with translations divisible by 4, and so on until a resolution of 1, ½ or ¼ pixel.

The local form of the similarity map or “SAD error shape” around the minimum detected by the coder gives an indication on the nature of the MBs. For example, if the MBs compared are highly textured, then the form of the similarity map around the minimum is very narrow (the values of the similarity map around the minimum are very much greater than this minimum) and, contrarily, for MBs with almost constant pixels, the form of the similarity map around the minimum is very splayed (the values of the similarity map around the minimum are very slightly greater than this minimum).

In accordance with the present invention, the form of the similarity map around the minimum detected by the coder is analyzed. Analysis of this form results in determining the three parameters for the calculation of the local convolution kernel of the Gaussian type used for the restoration of the current image.

For example, a textured MB is very little or not at all denoised in order not to degrade the details of the texture. In this case, the filtering used is defined by a narrow Gaussian smoothing, that is to say approaching the Dirac. A homogeneous MB is denoised more greatly, since no high-frequency detail appears. In this case, the filtering is defined by a wide Gaussian smoothing. For MBs having an edge, the filtering is defined by a Gaussian smoothing oriented according to the edge.

The flow diagram in FIG. 1 illustrates the main steps 12, 14, 16 and 18 of the restoration method according to the present invention as well as step 10 performed by the coder. These steps are detailed below.

Step 10 consists of a similarity calculation made by the coder for calculating the motion vector, as follows.

For a macroblock Mc to be coded of the current image Ic, the coder tests various macroblocks Mxy of the reference image Ir, in order to find the macroblock Mxₛyₛ, the most similar to Mc according to a similarity metric denoted s. The motion vector Vxy=(x,y) corresponds to the translation between the coordinates of Mc and Mxy.

The MBs to be coded are aligned on a grid according to the video standard used. In practice, an MB is typically the size of a square with sides of 16 pixels and the MBs to be coded are aligned on a grid with 16-pixel sides. Some recent video standards make it possible to code MBs in several sub-MBs with a lesser size, such as for example 8×8, 4×4, 4×8 or 8×4 pixels for the H.264 standard.

The macroblocks Mxy of the reference image Ir are freely positioned and are of the same size as the macroblock to be coded Mc. The coder seeks the macroblock Mxy such that the similarity measurement Sxy=s(Mxy,Mc) between Mxy and Mc is minimal or maximal with respect to all the Mxy candidates. The estimator s is said to be direct or inverse depending on whether the auto-similarity s(Mc,Mc) is zero or maximal, respectively. For example, the SAD is an inverse similarity estimator while the intercorrelation is a direct estimator.

The search set is defined by the coder. A search window is defined in order to specify the maximum and minimum coordinates of the motion vectors sought, for example (x,y)εR²/|x|<t,|y|<t, where R designates the set of real numbers and t is the size of the search window or zone (this zone is shown in dotted lines in FIG. 2).

The coordinates x and y can be integer or not, according to the video standard used. In the case of MPEG4 Part 2, the coordinates are multiples of ½, while for H.264 they are multiples of ¼.

In order to calculate the similarities with non-integer translations, it is necessary first of all to translate the pixels of the reference image Ir according to an interpolation specified by the standard used.

The coder generally proceeds by iterative searches commencing with integer coordinates such that (x,y)εN² where N designates the set of natural integers. When the macroblock Mxₑyₑ with integer translation (xₑ,yₑ) the most similar to Mc is found, the coder seeks at a sub-pixel resolution the macroblock Mxₛyₛ, with non-integer translation (xₛ,yₛ) most similar to Mc. It is generally observed that |xₛ−xₛ|<1 and |yₑ−yₛ|<1.

The invention is concerned with the various similarity measurement values Sxy calculated by the coder during the calculation of the optimal motion vector.

The values Sxy define a partial sampling of a two-dimensional surface called a similarity map (SMap), as illustrated in FIG. 3. The form of the SMap is complex and depends on the nature of the MB to be coded Mc and of the reference image Ir. At the point (xₛ,yₛ), the SMap is minimal or maximal (according to the estimator s).

As shown by the flow diagram in FIG. 1, step 12 consists of obtaining the values Sxy of the similarity map around the extremum (xₛ,yₛ).

For this purpose, a proximity criterion is chosen. For example, only the Sxy values such that |x−xₛ|<m and |y−yₛ|<m, are adopted, where m is a distance defining a selection window. The parameter m is typically equal to 1. The number nₛ of points Sxy selected by the proximity criterion depends on the number of intermediate calculations made by the coder, as well as the proximity criterion.

The following step 14 consists of modeling the similarity map. The model Ŝ_{xy} is chosen in order to characterize the extremum of the similarity map at the point (xₛ,yₛ). It is calculated by virtue of the various values of the similarity measurements Sxy close to the extremum according to the proximity criterion. This model is chosen so as to be simple, such as for example a Gauss function, or a parabola. This type of model is particularly well adapted to stationary signals and in particular to signals issuing from the similarity calculation.

The parameters of the model are for example calculated by the least squares method, or by other methods particular to the model.

In order to determine the parameters of the model Ŝ_{xy}, it is necessary to have a minimum number of measurements of the similarity Sxy. For example, a two-dimensional parabolic model is described by 6 parameters. Consequently, if nₛ is less than 6, it is necessary to calculate other values of Sxy, not calculated by the coder and close to the extremum point (xₛ,yₛ) according to the proximity criterion. These supplementary calculations are rapid since the coder has an effective estimator s.

It should be noted that the majority of coders typically supply nₛ=10 values for the motion vectors of integer coordinates; other measurements are made at sub-pixel resolutions. Thus it is frequent for the similarity values for integer coordinates (xₑ+i,yₑ+j) to be naturally calculated by the coder, the pair (i,j) defining the 4 or 8 closest neighbors of (xₑ,yₑ), as illustrated in FIG. 4.

The following step 16 consists of constructing a local filter dedicated to the restoration of the pixels of the macroblock Mc. The parameters of this local filter are extracted from the model Ŝ_{xy}. This is because the model Ŝ_{xy} is chosen so that its parameters can be converted into parameters characterizing the local filtering.

The local filter f is constructed in order to denoise, restore the contrasts or smooth the pixels of Mc. The filter f can take different forms, such as for example a convolution mask made from coefficients, or a median filter, or an oriented filter.

The filter f is defined for all types of restoration action, such as for example denoising, contrast heightening etc. The filter f is not constrained by the invention. It is characterized completely or partially with respect to the model Ŝ_{xy}. A few non-limiting examples of the filter f are given below:
A two-dimensional Gauss function defined by three parameters (orientation, major and minor semi-axes). These are characterized by the model Ŝ_{xy}. The Gauss function is then sampled on a convolution mask. Such a filter is similar to the convolution kernels of the PDE methods: the Gauss function is oriented according to the edge observed, the flattening of the Gauss function depends on the contrast of the edge observed.
The subtraction of two two-dimensional Gauss functions, with the same orientation, with proportional major semi-axes, proportional minor semi-axes, with different amplitudes. This filter is similar to the so-called “unsharp mask” filter, known to persons skilled in the art, oriented in a favored direction. The difference in amplitude is similar to the reinforcement parameter of the unsharp mask. The parameters (orientation, major and minor semi-axes) are characterized by the model Ŝ_{xy}. The whole is sampled on a convolution mask. This filter allows a controlled heightening of the contrast.
A one-dimensional convolution kernel oriented in the favored orientation of the model Ŝ_{xy}. The favored orientation is equal to the orientation of the edge observed on the MB to be coded. The pixels of the one-dimensional convolution mask are then associated either with convolution coefficients equal to 1 for an average smoothing, equal to the sampling of a Gauss function for a Gaussian oriented smoothing, or to non-linear methods, such as the median of the pixels of the mask.
A convolution kernel in which the pixels used for the filtering are circumscribed by an ellipse characterized by the model Ŝ_{xy}. The orientation, elongation and eccentricity of the ellipse issue from the model Ŝ_{xy}. The pixels circumscribed by the ellipse are said to be support pixels. They are used for the filtering. The filtered pixel is equal for example to the median of the support pixels, or the mean of the support pixels.

As shown by FIG. 1, step 18, which follows the step 16 of extraction of the parameters of the filter f from the model, consists of filtering the pixels of the MB to be coded Mc by means of the filter f. Therefore the filter f is applied to these pixels, without any edge effect. If the support of the filter f goes beyond Mc, then the adjoining pixels are used for the calculation. Each MB is therefore filtered by a particular filter characterized by the similarity map.

The current image thus filtered can then be used for the remainder of the coding. The motion vectors calculated by the coder from the non-filtered current image are unchanged.

A particular example embodiment is now described in more detail.

In order to simplify the writing of the indices, the following reference change is considered: i=x−xₑ and j=y−yₑ. It is a case of a translation by the vector (xₑ,yₑ). The similarity measurement Sxy therefore becomes Sij, the extremum in integer coordinates (xₑ,yₑ) becomes (0,0) and the extremum in non-integer coordinates (xₛ,yₛ) becomes (iₛ, jₛ).

For this particular example embodiment, the following parameters and conditions are defined:
The similarity estimator used by the coder is the SAD (or the MAD).
The model Ŝᵢⱼ is a two-dimensional parabolic function that is described by 6 parameters A, B, C, D, D, F, of the form:

Ŝᵢⱼ=A.i²+B.j²+C.i.j+D.i+E.j+F (1)
The filter f is a two-dimensional convolution kernel characterized by a Gauss function. f is the sampling of a Gauss function G(θ,σ₁,σ₂) defined by three parameters: the orientation θ, the maximum standard deviation σ₁ in the orientation θ and the minimum standard deviation σ₂ in the orientation θ+π/2.
Only the similarities Sij for the integer values of i and j are adopted.
The selection window contains the 9 values Sij, where i and j take independently the values (−1; 0; 1). If the coder does not supply all these values, it is necessary to calculate them. FIG. 4 illustrates the nine values adopted around the extremum of the SAD.

The six parameters of the parabolic model Ŝᵢⱼ described by equation (1) are calculated by means of the nine Sij values by the conventional method of least squares. FIG. 5 illustrates the nine values of SAD for MBs representing portions of images of different natures (elongate in zone 1, homogeneous in zone 2, textured in zone 3).

The parabolic model is in fact an elliptical paraboloid surface, as illustrated in FIG. 6. The plane P intersects the elliptical paraboloid surface in an ellipse, which is characterized by a semi-major axis a, a semi-minor axis b, and an orientation θ, which is the same as the orientation of the Gaussian-type smoothing filter, as explained below. The parameters a, b and θ must be calculated from the parameters A, B, C, D, E, and F in order to derive therefrom the parameters σ₁, σ₂ and θ of the filter f. The parameters a, b and θ of the ellipse are derived from the following system of equations:

$$\{ \begin{matrix}θ = \frac{1}{2} Arc tan ( \frac{C}{A - B} ) \\ a = 1 / {( A cos θ + B sin θ - C cos θsin θ )}^{2} \\ b = 1 / {( A sin θ + B cos θ + C cos θ sin θ )}^{2} \\ \end{matrix} \qquad ( 2 )$$

The system of equations (2) illustrates the well known properties of elliptical paraboloids and makes it possible to calculate the orientation θ, the semi-major axis a and the semi-minor axis b.

In order to convert the parameters of the ellipse into parameters of the filter f, the following points are observed:
the ellipse is oriented along the principal edge of the pixels of the MB to be coded Mc;
the ellipse is very small (a and b small) if the pixels of Mc are very textured;
the ellipse is very large (a and b large) if the pixels of Mc are very homogeneous (no high frequencies);
the ellipse is highly oriented (a>>b) if a contrasted edge appears on Mc.

The Gauss function characterizing the filter f must behave in the same way as the parameters of the ellipse: the parameters σ₁ and σ₂ must be proportional, according to an increasing monotonic function, to respectively a and b.

For example σ₁=k.In(a+1) and σ₂=k.In(b+1) are put where k is a scale parameter to be defined by the user. This formulation makes it possible to bring the variations of σ₁ and σ₂ into a range smaller than that of the values of a and b.

The filter f thus characterized is then used for the filtering step. It is applied to the pixels of the macroblock Mc. For this purpose, a convolution kernel of size 3×3 or 5×5 or of a greater size freely chosen is calculated by sampling of the Gauss function characterizing the filter f.

Each point m(i,j) of the convolution kernel of size N.N is equal to the sampling of the Gauss function at the point (i−N/2,j−N/2). The convolution kernel is normalized so that the integral is equal to 1, in order to preserve the mean intensities of the filtered pixels. The convolution mask is applied to all the pixels of the macroblock Mc. As described above, the convolution applies without edge effect; the pixels contiguous to Mc are used when the convolution kernel goes beyond the macroblock Mc.

In order to deal with the various luminance and chrominance planes (Y,U,V) of the video sequence, the filter f is applied to the macroblock Mc as well as to the corresponding pixels of the planes U and V. It is necessary obviously to take account of the resolutions of the various planes according to the coding format (such as for example 4:2:0 or 4:4:4).

In order to accelerate the calculations further, it is possible to simplify the particular example described above.

The improved variant proposed consists of modeling the 9 values Sij by 4 one-dimensional parabolic functions. The parameters of the 4 parabolic functions are then used conjointly in order to derive therefrom the form of the similarity map, which is modelled by 3 parameters: orientation, maximum concavity and minimum concavity.

Firstly, it is a case of modelling each triplet defined for the orientations o=0°, 45°, 90° and 135° by a parabolic function of the type SADₒ(t)=Aₒt²+Bₒt+Cₒ, where t represents the distance traveled on the line of orientation o centred on the middle of the 9 values of SAD. SADₒ(t) represents the value of the SAD along this line. Only the Aₒ that represent the concavities of the 4 one-dimensional parabolas previously defined are adopted. Calculation of the Aₒ values is extremely simple knowing SADₒ(t) for t=−1, 0 and 1. This gives Aₒ=(SADₒ(−1)+SADₒ(1))/2+SADₒ(0). The values of the concavities A_{0°}, A_{45°}, A_{90°} and A_{135°} are calculated in the following fashion according to the 9 values c₁ to c₉ of the SADs (these values are shown in the top part of FIG. 7):

A_{0°}=(c₆+c₄)/2−c₅

A_{45°}=(c₃+c₇)/2−c₅ (3)

A_{90°}=(c₂+c₈)/2−c₅

A_{135°}=(c₁+c₉)/2−c₅

The bottom part of FIG. 7 illustrates an example of various concavities calculated for an MB representing an edge oriented at approximately 45°. It will be noted that the value of the concavity A_{45°} is very small compared with the concavities for the other orientations (which corresponds to a parabola with a much more splayed dimension than the other three one-dimensional parabolas).

The orientation oₘ, associated with the minimum concavity, is not a precise measurement. In order to obtain an orientation oᵣ precise to within a few degrees, an interpolation is carried out.

Let Aₒ_{ₘ} be the minimum concavity of orientation oₘ and let Aₒ_{ₘ}₊₄₅ be the concavity in (oₘ+45°). The orientation oᵣ of the similarity map is calculated as illustrated in FIG. 8:

$$Δ = \frac{{A}_{{o}_{m} - 45} - {A}_{{o}_{m}}}{{A}_{{o}_{m} - 45} - 2 {A}_{{o}_{m}} + {A}_{{o}_{m} + 45}} - \frac{1}{2} \\ {o}_{r} = {o}_{m} + 45 Δ \qquad ( 4 )$$

Δε[−½; ½] represents the “off-centring” of oᵣ with respect to oₘ: Δ=0 if Aₒ_{ₘ}₋₄₅=Aₒ_{ₘ}₄₅; Δ=−½ if Aₒ_{ₘ}₄₅=Aₒ_{ₘ}.

It should be stated that the values of oₘ are considered in a circular fashion: if oₘ=0° then oₘ−45°=−45° mod(180°)=135°.

The minimum concavity Aₘᵢₙ and the maximum concavity Aₘₐₓ are calculated according to the following system of equations:

Aₘₐₓ=max(Aₒ)∀o

Aₘᵢₙ=Aₒ_{ₘ}−(Aₘₐₓ−Aₒ_{ₘ})·|Δ| (5)

Aₘₐₓ is the maximum value of the 4 concavities measured. Aₘᵢₙ is adapted according to the off-centring Δ. In the case of off-centring (Δ≠0), the measurement of Δₒ_{ₘ} is greater than the concavity Aₘᵢₙ, which is the absolute minimum sought. The formulation proposed makes it possible to take account of the variation in concavity and the off-centring.

Experience shows that the formulation of Aₘᵢₙ corresponds best to the absolute minimum concavity measurement. If the calculation of Aₘᵢₙ gives negative results, the zero value is adopted.

The relationships between oᵣ, Aₘᵢₙ, Aₘₐₓ and the filter f are described as follows:

$$\{ \begin{matrix}θ = {o}_{r} \\ {σ}_{1} = {e}^{- {A}_{min} / p} \\ {σ}_{2} = {e}^{- {A}_{max} / p}\end{matrix} \qquad ( 6 )$$

where p is a freely chosen scale parameter.

This formulation makes it possible to obtain small variations for σ₁ and σ₂, whereas Aₘᵢₙ and Aₘₐₓ have large amplitudes.

It should be noted that the concavity behaves as the inverse of the semi-axis defining an ellipse. A very small concavity corresponds to an ellipse having a great semi-axis; in this case, the convolution kernel must be large, since the associated MB is a homogeneous zone. The relationships between minimum and maximum concavities are therefore reversed compared with the parameters σ₁ and σ₂. The filtering function f being defined, the filtering step, in this improved variant, is similar to that of the particular example described previously.

FIG. 9 shows a particular embodiment of an information processing device able to function as a device for restoring a video sequence according to the present invention.

The device illustrated in FIG. 9 can comprise all or some of the means of implementing a restoration method according to the present invention.

According to the embodiment chosen, this device may for example be a microcomputer or a workstation 900 connected to various peripherals, for example a digital camera 901 (or a scanner, or any other image acquisition or storage means) connected to a graphics card (not shown) and thus supplying information to be processed according to the invention.

The microcomputer 900 preferably comprises a communication interface 902 connected to a network 903 able to transmit digital information. The microcomputer 900 also comprises a permanent storage means 904, such as a hard disk, as well as a reader for temporary storage means such as a disk drive 905 for cooperating with a diskette 906.

The diskette 906 and the hard disk 904 can contain software implementation data of the invention as well as the code of the computer program or programs whose execution by the microcomputer 900 implements the present invention, this code being for example stored on the hard disk 904 once it has been read by the microcomputer 900.

In a variant, the program or programs enabling the device 900 to implement the invention are stored in a read only memory (for example of the ROM type) 907.

According to another variant, this program or programs are received totally or partially through the communication network 903 in order to be stored as indicated.

The microcomputer 900 also comprises a screen 909 for displaying the information to be processed and/or serving as an interface with the user, so that the user can for example parameterize certain processing modes by means of the keyboard 910 or any other appropriate pointing and/or entering means such as a mouse, optical pen, etc.

A calculation unit or central processing unit (CPU) 911 executes the instructions relating to the implementation of the invention, these instructions being stored in the read only memory ROM 907 or in the other storage elements described. In particular, the central processing unit 911 is adapted to implement the algorithm illustrated on the flow diagram in FIG. 1.

When the device 900 is powered up, the processing programs and methods stored in one of the non-volatile memories, for example the ROM 907, are transferred into a random access memory (for example of the RAM type) 912, which then contains the executable code of the invention as well as the variables necessary for implementing the invention.

In a variant, the method of restoring the digital signal can be stored in various storage locations. In general terms, an information storage means that can be read by a computer or by a microprocessor, integrated or not in the device, possibly removable, can store one or more programs whose execution implements the method of restoring a video sequence described previously.

The particular embodiment chosen for the invention can be developed, for example by adding updated or enhanced processing methods; in such cases, these new methods can be transmitted to the device 900 by the communication network 903 or loaded into the device 900 by one or more diskettes 906. Naturally the diskettes 906 may be replaced by any information carrier deemed appropriate (CD-ROM, memory card, etc.).

A communication bus 913 affords communication between the various elements of the microcomputer 900 and the elements connected to it. It should be noted that the representation of the bus 913 is not limiting. This is because the central unit CPU 911 is for example able to communicate instructions to any element of the microcomputer 900, directly or by means of another element of the microcomputer 900.

1. A method of restoring a video sequence consisting of a plurality of images each comprising at least one block of pixels, comprising the steps of,
obtaining a plurality of values of the similarity in the sense of a similarity metric, between a bloc of pixels to be restored (Mc) in the current image and a plurality of blocks of a reference image (Ir) linked to the current image (Ic) by a motion vector field, using intermediate data obtained in the calculation of the motion vector field;
constructing a local restoration filter using the plurality of similarity values obtained; and,
applying said local restoration filter to the pixels of the block to be restored.

2. A method according to claim 1, wherein said intermediate data is the sum or mean of the absolute values of the differences between the values of the pixels of a block of the reference image (Ir) and the values of the corresponding pixels of the block to be restored of the current image (Ic).

3. A method of restoring a video sequence consisting of a plurality of images each comprising at least one block of pixels, said method comprising steps according to which:
the value of the similarity is calculated (10), in the sense of a similarity metric, between a block of pixels to be restored (Mc) in the current image and a plurality of blocks of a reference image (Ir) linked to the current image (Ic) by a motion vector field; and
the block of the reference image (Ir) for which the value of the similarity with said block of the current image (Ic) is an extremum is determined;
a similarity map is constructed (12) around said extremum, from the values of the similarity of the blocks of the reference image (Ir) close to, within the meaning of a proximity criterion, the block for which the value of the similarity is an extremum;
the similarity map is modeled (14) so as to obtain a model Ŝ_{xy} defined by a predetermined number of parameters;
a local restoration filter (f) is constructed (16) from the parameters of the model (Ŝ_{xy}); and
the pixels of the block to be restored (Mc) are filtered (18) by applying to them said local restoration filter (f).

4. A method according to claim 3, wherein, during the modeling step (14), the similarity map is modeled in the form of a surface.

5. A method according to claim 3, wherein the similarity metric consists of calculating the sum or mean of the absolute values of the differences between the values of the pixels of a block of the reference image (Ir) and the values of the corresponding pixels of the block to be restored of the current image (Ic) and in that the extremum is a minimum.

6. A method according to claim 4, in which a block is defined by its coordinates (x,y) and the block for which the value of the similarity is an extremum has (xₛ,yₛ) as its coordinates, wherein the proximity criterion consists of selecting the blocks whose coordinates satisfy |x−xₛ|<m and |y−yₛ|<m, where m is a predetermined distance.

7. A method according to claim 3, wherein, during the modeling step (14), the method of least squares is used.

8. A method according to claim 1, characterized in that the reference image (Ir) is the image preceding the current image (Ic) in the video sequence.

9. A method according to claim 3, characterized in that the reference image (Ir) is the image preceding the current image (Ic) in the video sequence.

10. A method according to claim 1, wherein said plurality of blocks in the reference image (Ir) is included in a search window of predetermined size.

11. A method according to claim 3, wherein said plurality of blocks in the reference image (Ir) is included in a search window of predetermined size.

12. A method according to claim 1, wherein the local filter is a convolution kernel or a median filter or an oriented filter.

13. A method according to claim 3, wherein the local filter is a convolution kernel or a median filter or an oriented filter.

14. A method according to claim 3, wherein the model (Ŝ_{xy}) is a two-dimensional parabolic function and the local filter (f) is a two-dimensional convolution kernel defined by a Gauss function.

15. A method according to claim 3, wherein the model (Ŝ_{xy}) consists of four one-dimensional parabolic functions.

16. A method according to claim 1, wherein the blocks of pixels are squares with sides of 16 pixels.

17. A method according to claim 3, wherein the blocks of pixels are squares with sides of 16 pixels.

18. A device for restoring a video sequence consisting of a plurality of images each comprising at least one block of pixels, said device comprising:
means for obtaining a plurality of values of the similarity, in the sense of a similarity metric, between a bloc of pixels to be restored (Mc) in the current image and a plurality of blocks of a reference image (Ir) linked to the current image (Ic) by a motion vector field, using intermediate data obtained in the calculation of the motion vector field;
means for constructing a local restoration filter using the plurality of similarity values obtained; and,
means for applying said local restoration filter to the pixels of the block to be restored.

19. A device for restoring a video sequence consisting of a plurality of images each comprising at least one block of pixels, said device comprising:
means for calculating the value of the similarity, within the meaning of a similarity metric, between a block of pixels (Mc) to be restored in the current image (Ic) and a plurality of blocks of a reference image (Ir) linked to the current image (Ic) by a motion vector field; and
means for determining the block of the reference image for which the value of the similarity with said block of the current image (Ic) is an extremum;
means for constructing a similarity map around said extremum, from values of the similarity of the blocks of the reference image (Ir) close to, within the meaning of a proximity criterion, the block for which the value of the similarity is an extremum;
means for modeling the similarity map, adapted to obtain a model (Ŝ_{xy}) defined by a predetermined number of parameters;
means for constructing a local restoration filter (f) from the parameters of the model (Ŝ_{xy}); and
means for filtering the pixels (Mc) of the block to be restored, adapted to apply the local restoration filter (f) to said pixels.

20. A device according to claim 19, wherein the modeling means are adapted to model the similarity map in the form of a surface.

21. A device according to claim 19, wherein the similarity metric consists of calculating the sum or mean of the absolute values of the differences between the values of the pixels of a block of the reference image (Ir) and the values of the corresponding pixels of the block to be restored of the current image (Ic) and in that the extremum is a minimum.

22. A device according to claim 19, wherein the modeling means are adapted to use the least squares method.

23. An information storage means that can be read by a computer or a microprocessor storing instructions of a computer program allowing the implementation of a method of restoring a video sequence consisting of a plurality of images each comprising at least one block of pixels, comprising the steps of,
obtaining a plurality of values of the similarity in the sense of a similarity metric, between a bloc of pixels to be restored (Mc) in the current image and a plurality of blocks of a reference image (Ir) linked to the current image (Ic) by a motion vector field, using intermediate data obtained in the calculation of the motion vector field;
constructing a local restoration filter using the plurality of similarity values obtained; and,
applying said local restoration filter to the pixels of the block to be restored.

24. An information storage means that can be read by a computer or a microprocessor storing instructions of a computer program allowing the implementation of a method of restoring a video sequence consisting of a plurality of images each comprising at least one block of pixels, said method comprising steps according to which:
the value of the similarity is calculated (10), in the sense of a similarity metric, between a block of pixels to be restored (Mc) in the current image and a plurality of blocks of a reference image (Ir) linked to the current image (Ic) by a motion vector field; and
the block of the reference image (Ir) for which the value of the similarity with said block of the current image (Ic) is an extremum is determined;
a similarity map is constructed (12) around said extremum, from the values of the similarity of the blocks of the reference image (Ir) close to, within the meaning of a proximity criterion, the block for which the value of the similarity is an extremum;
the similarity map is modeled (14) so as to obtain a model Ŝ_{xy} defined by a predetermined number of parameters;
a local restoration filter (f) is constructed (16) from the parameters of the model (Ŝ_{xy}); and
the pixels of the block to be restored (Mc) are filtered (18) by applying to them said local restoration filter (f).

25. A computer program product able to be loaded into a programmable apparatus, containing sequences of instructions for implementing, when this program is loaded into and run by the programmable apparatus, a method of restoring a video sequence consisting of a plurality of images each comprising at least one block of pixels, comprising the steps of,
obtaining a plurality of values of the similarity in the sense of a similarity metric, between a bloc of pixels to be restored (Mc) in the current image and a plurality of blocks of a reference image (Ir) linked to the current image (Ic) by a motion vector field, using intermediate data obtained in the calculation of the motion vector field;
constructing a local restoration filter using the plurality of similarity values obtained; and,
applying said local restoration filter to the pixels of the block to be restored.
